(19) United States
(12) Patent Application Publication
(10) Pub. No.: US 2004/0006292 A1
(43) Pub. Date: Jan. 8, 2004

(54) Pressure point sleeve and balls device which allows user to adjust presure position on their back muscles and spine

(76) Inventors: Robert A. Joseph, Reseda, CA (US); Teo L. Hunter, Canoga Park, CA (US)

Correspondence Address: John S. Nagle, Esq., 21757 Devonshire St., Ste 15, Chatsworth, CA, 91311, US

(21) Appl. No.: 10/190,034

(22) Filed: Jul. 8, 2002

(51) Int. Cl. A61H 15/00

(52) U.S. Cl. 601/121; 601/134

(57) ABSTRACT

A new mechanical device for applying therapeutic precisely placed pressure to the neck, back, and spine is described, where the device comprises: a main body of cylindrical shape comprised of an inner elastic sleeve and an outer sleeve, said inner and outer sleeves being integrally secured together to form the main body, said main body having a diameter of from 2 to 15 cm.; and 1 to 12 balls having a diameter equal to or slightly larger than said opening in said main body. One or both ends of the device may be open to allow the user to add or remove balls inside the sleeve.

### FIELD AND BACKGROUND OF THE INVENTION

The present invention relates to a simple device for controlling the application of pressure from one or more balls adjustably set inside a two layer sleeve of material which will hold one or more balls in place, so that the user may precisely adjust pressure applied to his or her back or neck muscles, tissues, or spine, while they sit, lay down, or lean against a flat object. The important therapeutic application is first to apply pressure to the desired spot, and second to allow a very limited massage action if the user moves their body area to be massaged. Many pressure point application devices have been invented and marketed which apply pressure to the feet using raised balls set in a base where the balls may spin or move. But, until the present invention, no artisan had achieved a device which allows the adjustable precise point pressure action on the back, neck, and spine tissues without mechanical application of pressure using the fingers and hands performed by a chiropractor or physical therapist. Further description of the present invention is disclosed as it is compared to other therapeutic devices, below.

Two other artisans have put movable balls inside a sleeve. Robbin Russel, U.S. Pat. No. 5,628,772 invented a therapeutic massage mask comprised of an elongated resilient plastic pouch having a length and width which is greater than the thickness thereof, where the pouch is filled a plurality of spherical balls made of a thermal transfer material such as hard plastic or hollow spheres filled with ice. Migraine headache sufferers are to use the device near the eyes to apply a thermal treatment and massage treatment by applying a gentle rolling pressure against the eyes. The frozen balls are not interconnected and they roll relative to each other when moving the mask back and forth against the eyes (U.S. Pat. No. 5,628,772, Col. 4, lines 41-48). In the present invention the balls do not freely move because they are held in place by an elastic inner sleeve which grabs the ball so that its movement is very limited.

Teresa Suia, U.S. Pat. No. 5,545,456, invented a wash cloth that cleans and massages. It is comprised of a plurality of pockets for the insertion of soap and or massaging utensils and has a handle at either end so that the user can move the wash cloth up or down or from side to side to achieve a massaging action against their back. Suia's invention differs from the present invention in that it is not made up of a double sleeve so as to prevent movement of the balls and in Suia's device the balls can turn or move, freely. The whole therapeutic device is intended to be moved from side to side using the hands and arms, whereas in the present invention, the device is intended to be left stationary against the back with limited movement of the balls which are flexible and can apply point pressure to a specific spot on the back Moreover, in both Russel and Suia's inventions, the balls cannot be positioned at will to provide prolonged point pressure in a specific spot, as in the present invention. The present invention may be used on back and neck tissues and the tail bone and back pelvic area, with good results.

### OBJECTS OF THE INVENTION

One object of this invention is to provide precise application of prolonged pressure in one or several or many spots over the spine, neck, back, or rear pelvic region, so as to relieve back pain and or ameliorate disorders of the neck, back, and or spine. Another object of this invention is to provide for a limited massage action to the precise places on the neck or back or pelvic or tail bone areas, where the balls inside the dual sleeve press against. Another object of the invention is to provide a device which cannot only do the above, but allows the user to adjust the precise spot or spots where the pressure is being applied. More than one of the present invention therapeutic devices can be used by a user at a given time so, as to apply pressure to different regions of their body, at the same time.

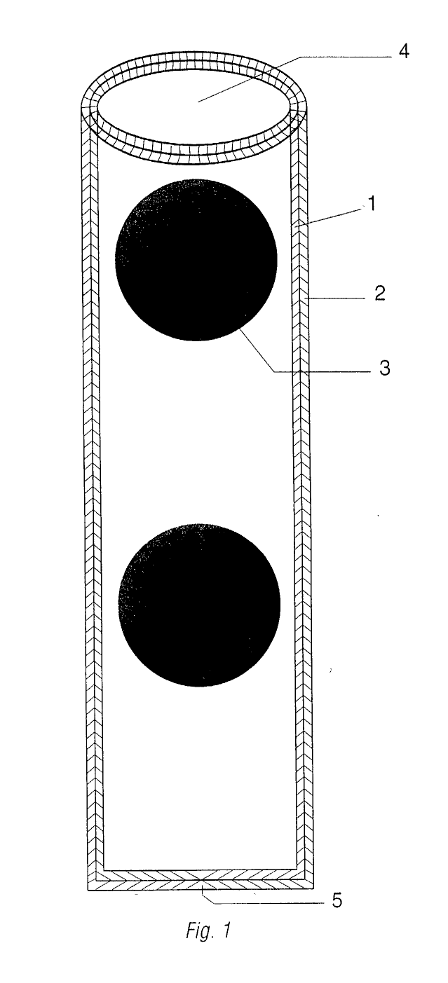

Other objects and features of the present invention will become apparent to those skilled in the art from the following detailed description of a preferred embodiment of the invention as shown in FIG. 1.

### BRIEF DESCRIPTION OF THE DRAWING

The invention will appear more clearly when taken in conjunction with the accompanying drawing showing, by example, one preferred embodiment of the present invention. FIG. 1 is a lengthwise split, dissected down the middle, view of a preferred embodiment of the present invention, showing two balls contained within an inner elastic material sleeve and an outer sleeve of a non-elastic soft material, such as rayon or other synthetic fibers, or velvet, wool, flannel or cotton. The inner and outer sleeve may be closed at both ends, or alternatively left open at one or both ends to allow the insertion of additional balls, if desired by the user.

### DESCRIPTION OF A PREFERRED EMBODIMENT

Referring now in greater detail to the embodiment shown in FIG. 1, the inner elastic sleeve which grabs the balls or balls is designated with the reference numeral 1, while the outer sleeve of soft material is designated with the reference numeral 2. The ball is designated by reference numeral 3. Reference numeral 4 shows an open end of the inner and outer sleeve and reference numeral 5 shows a closed end of the inner and outer sleeve. In a preferred embodiment, the length of the dual, inner and outer sleeve is from 24 cm. to 120 cm. and the diameter of the opening is from 2 cm. to 15 cm. Stitching of various sorts may be used to secure the inner sleeve to the outer sleeve and is also used to close at least one end of the dual sleeve device.

### ADDITIONAL EMBODIMENTS AND EXAMPLES

In relation to the elastic inner sleeve, any material having elastic properties is sufficient to accomplish that element of the invention. Materials which are elastic are well known to those skilled in the art and are numerous. The outer coaxial sleeve is preferably of a soft material and it may also possess elastic properties and still adequately function as an element of the instant invention. The ball or balls placed inside the sleeve may range in diameter from 2 cm. to 15 cm., and the number of balls used may vary from 1 to 12. The balls may be made of a hard material or plastic or elastomeric or rubber material, Stitching used to secure the inner sleeve to the outer sleeve may be of any sort so long as it secures the two elements together. Stitching used to lengthwise sew up the inner sleeve tube and lengthwise sew up the outer sleeve tube or to close off an end may be of any sort so long as it is fashioned to remain secure.

In a most preferred embodiment the balls are tennis ball cores.

The foregoing description of the preferred embodiment of the invention is to be considered as illustrative and not as limiting. For example, the device may be applied to areas other than the neck and back. Various minor changes and modifications will occur to those skilled in the art, for example, lengthening the ends of the device or putting handles on the ends of the device to allow the user to more easily handle it. Changes and modifications will occur to those skilled in the art for performing substantially the same function in substantially the same way, to achieve substantially the same result, without departing from the true scope of the invention as defined in the appended claims.

The below claims are incorporated by reference into this specification.

What is claimed is:

1. A pressure point application and massage device comprising, a main body of cylindrical shape comprised of:
an inner elastic sleeve and an outer sleeve, said inner and outer sleeves being integrally secured together to form the main body, said main body having at least one open end wide enough to receive balls having diameter of from 2 to 15 cm.;
and 1 to 12 balls having a diameter equal to or slightly larger than said opening in said main body.

2. The pressure point application and massage device of claim 1, wherein, said balls are tennis ball cores.

3. A pressure point application and massage device comprising, a main body of cylindrical shape comprised of:
an inner elastic sleeve and an outer sleeve, said inner and outer sleeves being integrally secured together to form the main body, said main body having a diameter of from 2 to 15 cm.;
and 1 to 12 balls placed inside the sleeve having a diameter equal to or slightly larger than 2 to 15 cm.

4. The pressure point application and massage device of claim 3, wherein, said balls are tennis ball cores.
